(19) United States
(12) Patent Application Publication
(10) Pub. No.: US 2003/0196456 A1
(43) Pub. Date: Oct. 23, 2003

(54) Crystallized decorative construction materials and methods for their production

(75) Inventor: Pavel Linhart, Jihlava (CZ)

Correspondence Address: FOLEY & LARDNER, 150 EAST GILMAN STREET, P.O. BOX 1497, MADISON, WI, 53701-1497, US

(73) Assignee: Jack Walters & Sons / Futuristic Tile

(21) Appl. No.: 10/124,490

(22) Filed: Apr. 17, 2002

(51) Int. Cl. C03C 10/00

(52) U.S. Cl. 65/33.1; 428/428; 428/325; 428/426

(57) ABSTRACT

The present invention provides a construction material for internal and external use in buildings and other architectural structures. The material is made from a glassy material that has been crystallized in the presence of crystalline seed particles. The construction material has higher mechanical strength and lower water absorption than conventional glass based construction materials. The invention also provides methods for producing these improved construction materials.

### FIELD OF THE INVENTION

The present invention relates to decorative construction material for use as internal and external tiling on buildings and other structures. More particularly, the invention relates to crystallized construction materials made from glassy materials and crystallized seed particles.

### BACKGROUND OF THE INVENTION

The internal and external tiling of buildings and other architectural structures is commonly made from natural and artificial construction materials including ceramic tiles of various types. In addition to being decorative, these construction materials should be durable, weather resistant, thermally insulating, scratch resistant, and economical to produce and install. Unfortunately, conventional ceramics and other natural materials used to make these construction materials are expensive in terms of both raw materials and construction costs.

One solution that may be used to avoid the high cost of these conventional materials is to make construction materials from glass, particularly waste glass, which is relatively inexpensive. Many methods are known for recycling waste glass, including grinding the glass into particles followed by melting or sintering the particles into new glass objects. However, because glassy materials are amorphous, having a disorganized structure, they have a lower mechanical strength than construction materials having a more organized or crystallized structure.

It is possible to produce a construction material having a relatively high degree of order through the careful processing of a glassy starting material. However, the process of producing a material having an ordered structure from a glassy material is a slow and relatively inefficient multi-step procedure. In the first step, the glassy starting material is heated to temperature near its softening point and held at that temperature until crystallized seed nuclei form within the body of the material. The second step typically involves heating the material to near its liquidus temperature and maintaining that material at this elevated temperature until the material becomes crystallized through slow crystal growth about the nuclei. Of the two steps, it is the first step that is the most time consuming. In order to achieve an adequate degree of crystallization, the material must normally be processed through this two-step cycle multiple times.

Thus, a need exists for a simple and inexpensive process for making a construction material having high mechanical strength using glass as a starting material.

### SUMMARY OF THE INVENTION

The present invention provides crystallized construction materials having high mechanical strengths that are produced from glassy materials and methods for making the same. More specifically, the invention provides crystallized construction materials made by crystallizing glass granulate in the presence of pre-formed crystalline seed particles that are capable of acting as nucleation sites for the crystallization process.

One aspect of the invention provides a construction material comprising a single layer of crystallized material that is produced from a mixture of glass granulate and crystalline seed particles wherein the mixture has been thermally treated to crystallize the glass granulate in the presence of the crystalline seed particles. In various embodiments of the invention, the glass granulate is comprised of waste glass. In addition, this aspect of the invention provides a double layer construction material comprising a glassy layer disposed on top of the above-described crystallized layer.

Another aspect of the invention provides a method for producing a construction material by forming a layer containing a mixture of glass granulate and crystalline seed particles and crystallizing the glass granulate in the presence of the seed particles. In one embodiment of the invention, the method produces a double layer construction material by forming a first layer comprising a mixture of glass granulate and crystalline seed particles, disposing a second layer comprising glass granulate on top of the first layer, crystallizing the glass granulate in the first layer in the presence of the seed particles and sintering the glass granulate in the second layer. Again, in various embodiments, the glass granulate may comprise waste glass.

### BRIEF DESCRIPTION OF THE DRAWINGS

FIG. 1 is a cross-sectional view of a heat resistant mold containing a single layer construction material.

FIG. 2 is a cross-sectional view of a heat resistant mold containing a double layer construction material.

FIG. 3 is a diagram of the heating and cooling stages for the thermal processing of a one or two layer construction material. In this figure, TP stands for the temperature during the preheating step, TF stands for the temperature during the firing step, TC stands for the temperature during the fast cooling step, and TA stands for the temperature during the annealing step. The numbers following each of these abbreviations correspond to the individual heating stages that take place during the thermal processing.

FIG. 4 is a cross-sectional view of a heat resistant mold containing a crystallized material made from glass granulate for use in producing seed particles. The abbreviations in the figure are the same as those in FIG. 3.

FIG. 5 is a diagram of the heating and cooling stages for the thermal processing of crystalline seed particles for use with the present invention. The abbreviations in the figure are the same as those for FIG. 3.

FIG. 6 is a graph showing the expansion of the first and the second layer in a two layer material as a function of temperature.

### DETAILED DESCRIPTION OF THE INVENTION

The present invention provides a construction material for internal and external use in buildings and other architectural structures. The material is made from a glassy material that has been crystallized in the presence of crystallizine seed particles. The construction material has higher mechanical strength and lower water absorption than conventional glass based construction materials. The invention also provides methods for producing these improved construction materials.

Various terms will be used extensively and repeatedly throughout the application. Therefore, in order to facilitate a better understanding of the invention, these terms are defined for the purposes of the present invention as follows.

Glass: For the purposes of this invention, the term glass means a noncrystalline, or primarily noncrystalline material made from the fusion of silica and/or silicates typically with soda and lime. (e.g. soda-lime-glass) A typical glass contains silica and other inorganic oxides, including sodium, potassium, calcium, magnesium, aluminum, barium, boric and lead oxides.

Glass granulate: Glass granulate is comprised of glass pieces or particles that may be made from new glass, waste glass, or recycled glass. Glass granulate may be made from particles of colored or uncolored glass.

Waste glass: Waste glass is glass in the form of scrap or waste collected from industrial or residential waste. Examples of waste glass may include glass obtained from objects such as bottles or windows.

Crystalline seed particles: Crystalline seed particles are mineral particles having a crystalline structure that are capable of acting as nuclei for the crystallization of a glassy material that has been heated to a temperature sufficient to sinter the material.

Softening point temperature: Softening point temperature as used herein means the Littleton softening point temperature which is the temperature at which the viscosity of a given glass is 10^{7.65} poise.

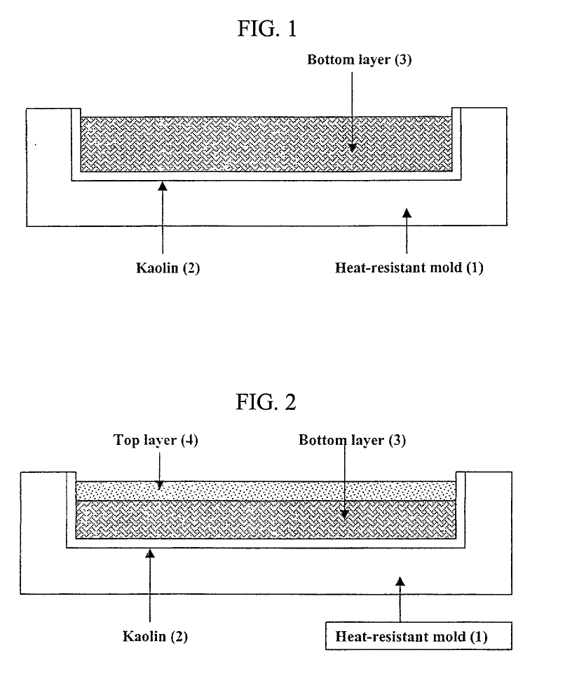

One aspect of the invention provides a single layer construction material as shown in FIG. 1. This construction material is comprised of a layer of crystallized material 3 produced from a mixture of glass granulate and pre-formed crystalline seed particles wherein the mixture has been thermally treated to crystallize the glass granulate in the presence of the crystalline seed particles. By pre-formed, it is meant that the crystalline seed particles are formed prior to mixing and thermal processing. The glass granulate may be comprised of any type of glass, however, heat resistant glasses, such as pyrex, simax, and vycor, are less suitable due to the difficulties inherent in the heat processing of such glasses. In one embodiment the glass granulate is made from a Na₂O—CaO—SiO₂ type glass. In various embodiments, the glass granulate may comprise a waste glass. This is particularly advantageous because it significantly reduces the cost of the construction material.

The seed particles in the present invention may be comprised of various crystalline mineral particles and mixtures of various crystalline mineral particles that serve as nuclei for the crystallization of the glassy materials. The seed particles are themselves formed by the devitrification of glassy materials, preferably waste glass. In various embodiments, the crystalline mineral particles may contain silicates, and more specifically, may contain silicates from the quartz group including the minerals tridymite (SiO₂) and cristobalite (SiO₂). The minerals devitrite (Na₂O.3CaO.6SiO₂), wollastonite (CaO.SiO₂), and diopside (CaO.MgO.2SiO₂) are other examples of a crystalline mineral particles that may be used as seed particles in the present invention.

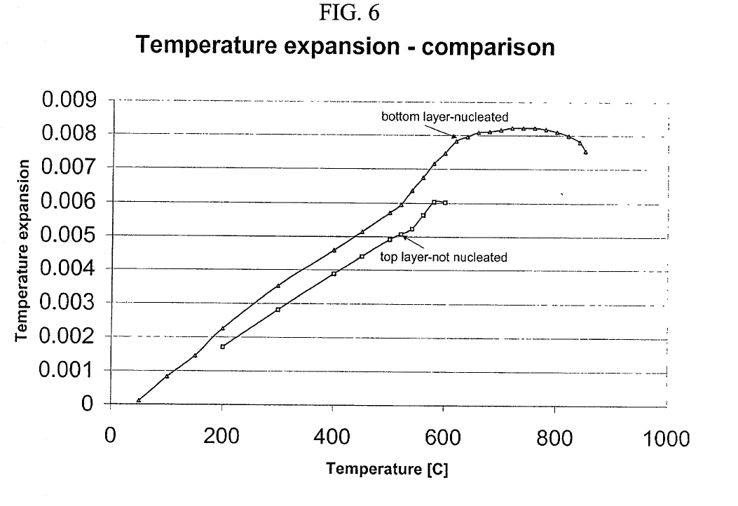

The crystallized construction materials according to this invention have a higher mechanical strength and lower water absorption than other glass based construction materials currently available. Specifically, the construction materials have a mechanical strength of at least 20 MPa and in some instances at least 30 MPa and a water absorption below 0.2% and in some instances below 0.15%. This represents a substantial improvement over other glass based construction materials which generally have a mechanical strength of less than 12 MPa and a water absorption of at least 0.5%. In addition, the crystallized materials of the present invention demonstrate a higher thermal expansion than conventional, amorphous, glass based materials, as demonstrated in FIG. 6 below.

Typically, the seed particles will have a diameter of less than 1 millimeter. This includes embodiments wherein the diameter of the seed particles is less than about 0.5 millimeter and further includes embodiments wherein the diameter of the seed particles is less than about 0.3 millimeter.

The glass granulate may be ground to a uniform particle size and may have an average particle diameter of less than about 4 millimeters. This includes embodiments wherein the particle diameter is less than about 2 millimeters and further includes embodiments wherein the particle diameter is less than about 1 millimeter. In one embodiment, the mixture of the glass granulate and the crystalline seed particles used to produce the construction material comprises between about 75 and about 98% glass granulate by weight and between about 2 and about 25% crystalline seed particles by weight. This includes embodiments wherein the mixture comprises between about 92 and about 98% glass granulate by weight and between about 2 and about 8% crystalline seed particle by weight and further includes embodiments wherein the mixture comprises between about 95 and about 98% glass granulate by weight and between about 2 and about 5% crystalline seed particle by weight.

The present invention also provides a two layered crystallized construction material as shown in FIG. 2. This construction material is made from a layer of glassy material 4 disposed on top of the above-described crystallized layer 3. In various embodiments, the second glassy layer is formed from sintered glass granulate. In this embodiment, the upper glassy layer may serve as a decorative layer while the bottom layer provides the material with enhanced mechanical strength. In various embodiments the temperature dependence of the expansion of the first layer and the temperature dependence of the expansion of the second layer are substantially the same. In other embodiments the bottom crystallized layer has a higher coefficient of thermal expansion than the upper glassy layer. This is advantageous because it produces a material having enhanced mechanical strength. This enhanced strength results from the thermal processing of the two layers which involves firing the layers at high temperatures followed by annealing. During the annealing process the bottom layer compresses the top layer at the interface between the two layers, creating an area of compressive tension. The compressive tension corresponds to higher strength. The combination of the high mechanical strength of the crystallized layer and the compressive tension at the interface results in an unusually strong construction material.

The glass granulate used to make the second glassy layer may be ground to a uniform size and may have an average particle diameter of greater than about 1 millimeter. The glass granulate used to make the second layer may be the same type of glass used to produce the first layer, or may be of a different type.

Another aspect of the invention provides a method for producing the above-described crystallized construction materials from glassy materials. The method produces construction materials that have higher mechanical strength than conventional glass based construction materials by accelerating the crystallization process inside the body of the material during processing. Because glass processing can be run at a faster rate in the present method compared to conventional methods, the method of this invention has the additional advantage of lower production costs.

Without wishing to be bound to any particular theory, the inventor believes the improved mechanical strength of the construction material of the present invention results from the acceleration of the crystallization process. Traditionally, glassy materials are crystallized in a time consuming two step process. In the first step, the glassy starting material is heated to a temperature near its softening and held at that temperature until crystallized seed nuclei form within the body of the material. The second step typically involves heating the material to near its liquidus temperature which promotes slow crystal growth about the nuclei. While both steps are quite slow, it is the first step that is the most time consuming. The present invention is based on the inventor's discovery that the slow nuclei formation step can be circumvented by pre-forming the crystalline nuclei and adding them to the starting materials.

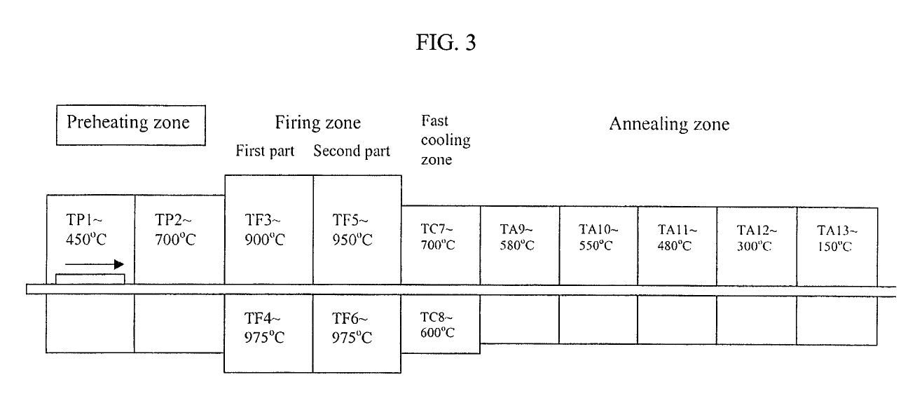

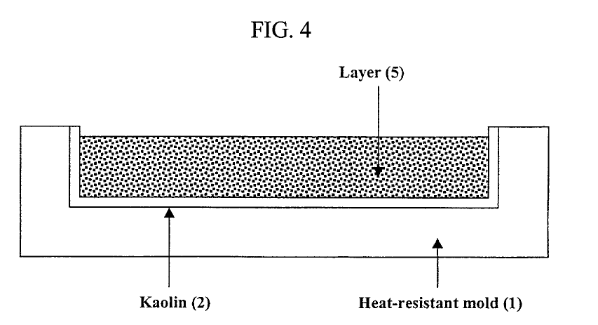

One embodiment of the invention provides a method for producing a single layer construction material by forming a layer comprising a mixture of glass granulate and crystalline seed particles and devitrifying the glass granulate in the presence of the seed particles. In one embodiment the mixture is substantially free of other nucleating agents, such as MgO, TiO₂, F, Cr₂O₃, sulfides, and phosphates. The elimination of such agents is advantageous because it significantly reduces processing costs. FIG. 3 shows the temperature profile for the thermal processing of a construction material according to the present invention. In a typical embodiment, the devitrification of the glass granulate can be accomplished by preheating the layer 3 to a temperature sufficient to burn off any impurities in the layer, further heating the layer to a temperature sufficient to crystallize the glass granulate in the presence of the seed particles and finally, cooling the layer at a rate sufficient to anneal the material.

The mixture of glass granulate and crystalline seed particles may be formed into a layer 3 by placing a mixture of glass granulate and crystalline seed particles into a heat resistant mold 1 made of a material having the same or smaller coefficient of thermal expansivity than the glass granulate used. The inner surface of the mold may be ground and covered with a fluid solution of kaolin 2. Kaolin will not sinter during thermal treatment and, therefore, facilitates removal of the final product from the mold.

The heating steps described above can be carried out in an reservoir, furnace, oven, or kiln. During the preheating step, the layer may be heated from the bottom. This is advantageous because it reduces bubble formation in the material, resulting in a more uniform and flawless final product as discussed in U.S. Pat. No. 6,042,905, which is herein incorporated by reference. The preheating temperature will depend on the nature of the glass granulate used in the mixture. However, typical preheating temperatures for waste glass made from such components as window glass or bottle glass will be between about 700° C. and about 750° C. In certain embodiments, the preheating temperature will be between about 720° C. and about 730° C. The preheating steps may occur in stages wherein the materials are first exposed to a lower temperature for a predetermined period and then exposed to the final preheating temperature. Typically, the first stage in this two-stage process will involve heating the materials to a temperature of between about 400° C. and about 500° C. for between about 15 to about 30 minutes. The total preheating time will vary depending on the nature of the particular glass granulate used to make the layer. However, for a typical sample of waste glass granulate, the total preheating time will last between approximately 30 minutes and one hour and may last between 40 and 50 minutes.

Once the preheating process is completed, the layer is fired at a temperature sufficient to devitrify the glass granulate in the presence of the seed particles. As the temperature increases, the rate of crystal growth on the pre-formed nuclei increases until the growing nuclei consume the remainder of the glass. During the firing process, the layer may be heated from the top and from the bottom. The firing temperature, firing time, heating rate, and the rate of crystallization will depend on the particular glass granulate used to make up the mixture. However, for a typical waste glass composition, the material in the firing zone should be heated to a temperature between about 800° C. and about 1000° C. at a rate of between about 5 and about 10° C. per minute. In one embodiment of the invention, the bottom of the layer is heated to a temperature of between about 975° C. and 1,000° C. and the top of the layer is heated to a temperature of between about 850° C. and 950° C.

In yet another embodiment of the invention, the firing process takes place in two stages. In the first stage, the bottom of the layer is heated to a temperature between about 975° C. and 1,000° C. and the top of the layer is heated to a temperature of between about 850° C. and 900° C., while in the second phase, the temperature of the bottom of the layer is maintained at between about 975° C. and 1,000° C. and the temperature at the top of the layer is increased to about 950° C. The total firing time will depend on the nature of the glass granulate that goes into the layer. However, for a typical layer made of waste glass granulate, the firing time will be between about 30 minutes and about one hour, including embodiments wherein the firing time is between approximately 40 and 50 minutes. If a two-stage process is used, the firing time for each stage will be approximately 20-30 minutes.

In the final step of the method for producing a construction material according to the present invention, the layer is cooled at a rate sufficient to anneal the materials in the layer. The cooling process may involve multiple cool down steps at progressively cooler temperatures. In one embodiment, the layer is cooled to reduce the temperature of the material to a temperature of approximately 650° C. to 750° C. and then further cooled to a temperature of between approximately 500° C. and 600° C. and maintained at that temperature for a time sufficient to eliminate any temperature gradient in the layer. The layer may then be cooled still further to a temperature of between about 450° C. and 500° C., followed by a further annealing step wherein the temperature of the layer is lowered to a temperature of between approximately 125° C. and 175° C. The total cooling time, as well as the cooling time for each stage in the multiple step process, will depend on the dimensions of the layer and on the particular glass granulate used as the starting material to make the layer. However, for a typical layer made of waste glass granulate, the initial cooling steps will last from between about 20 and about 30 minutes, and the final annealing step will last between approximately 45 minutes and one hour.

One embodiment of the present invention provides a process for making a two layer construction material comprising a decorative glassy layer disposed on top of a crystallized layer having enhanced mechanical strength. This method comprises forming a first crystallized layer comprising a mixture of glass granulate and crystalline seed particles, disposing a second glassy layer comprising glass granulate on top of the first layer, crystallizing the glass granulate in the first layer in the presence of the seed particles, and sintering the glass granulate in the second layer. FIG. 3 shows the temperature profile for the thermal processing of a construction material according to the present invention. The double layer structure may be produced by placing a mixture of glass granulate and crystalline seed particles in a mold 1 to produce a lower layer 3 followed by adding a layer of glass granulate on top of the lower layer to produce an upper layer 4. The two layers contained within the mold are then subject to a preheating process, a firing process, and a cooling process as described above for the method of making a single layer construction material. In this embodiment, the firing cycle, and in particular, the second stage of a two stage firing cycle, serves not only to crystallize the glass granulate starting material in the first layer, but also serves to sinter the glass granulate in the top layer creating a non-porous decorative glassy layer which may be mechanically polished or sandblasted.

The crystalline seed particles for use in the present invention may themselves be produced from amorphous starting materials including recycled or water glass granulate, including waste glass tiles. Alternatively, the seed particles can be made by grinding preexisting crystallized tiles, scrap pieces of preexisting crystallized tiles, or shavings from preexisting crystallized tiles, including crystallized tiles made according to the present invention. This approach is advantageous because waste is reduced by reprocessing unused crystallized tiles or portions thereof. In one embodiment, the seed particles are made from the devitrification of a glass granulate composition that is substantially identical to the glass granulated composition that is subsequently mixed with the seed particles to form the crystallized construction materials according to the methods discussed above.

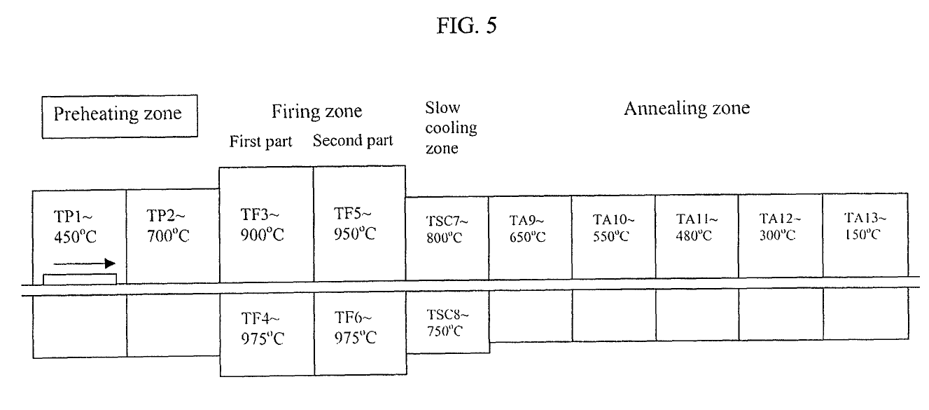

One aspect of the present invention provides a method for producing crystallized seed particles from amorphous starting materials for use in the production of the crystallized construction materials described above. FIG. 5 shows the temperature profile for the thermal processing of a crystallized material that can be ground into seed particles. This method includes the step of heating a layer of glass granulate which may be contained in a heat resistant mold 1 made of a material having the same or a smaller coefficient of thermal expansivity than the glass granulate. The inner surface of the mold may be ground and covered with a fluid solution of kaolin 2 which does not sinter during thermal processing and which, therefore, facilitates removal of the final glass product from the mold. During processing, the layer of glass granulate 5 is subject to preheating, firing, and finally cooling and annealing. This heat treatment converts the oxides that compose the glass into a crystalline phase. The thermal processing is followed by a grinding step wherein the newly formed and crystallized product is ground to a uniform particle size. In various embodiments, the average particle diameter, after the grinding step, will be less than about 1 millimeter.

The preheating step generally entails heating the layer of glass granulate to a temperature sufficient to burn off any impurities present within the glass granulate and to trigger the formation of crystalline seed particles or nuclei within the glassy material. This generally entails heating the material to a temperature near the softening point temperature of the glass granulate. One of skill in the art will recognize that this temperature and the rate of heating will vary depending on the specific glass granulate used. However, for a typical waste glass, the preheating temperature will be between about 700° C. and 750° C. at a rate of about 10 to about 15° C. per minute. The preheating step may take place in two stages wherein the materials are first heated to a lower temperature for a predetermined time before being heated to the final preheating temperature. The duration of the preheating stage will depend on the precise nature of the glassy material used to make up the layer. However, for a layer made from typical waste glass, the preheating time will last between approximately 30 minutes and one hour.

Once the preheating process is completed, the materials are fired at a temperature sufficient to promote the slow crystallization of the glass granulate about the crystalline seed particles that were formed during the preheating step. As the temperature is increased the rate of nuclei formation decreases and the rate of crystal growth about the nuclei increases until the nuclei grow, and eventually, consume the remainder of the glass. Again, both the temperature, the rate of heating, and the duration of the firing process will depend on the particular nature of the materials chosen. However, for granulate made of typical waste glass, the firing temperature will be between approximately 900° C. and 1,000° C. and the rate of heating will be between about 5 and about 10° C. per minute. In one embodiment, the firing process is a two stage process wherein the materials are heated from the top and the bottom. In this embodiment, the bottom of the mold containing the glass granulate is heated to a temperature between about 975° C. and 1,000° C., and the top of the mold is heated to a temperature of about 900° C. for between approximately 20 and 30 minutes. In the second stage of this firing process, the temperature at the bottom of the mold is maintained at between about 750° C. and 1,000° C., while the temperature at the top of the mold is increased to approximately 950° C. for a period of approximately 20 and about 30 minutes.

After the firing process is completed, the material is slowly cooled at a rate sufficient to anneal the material. This slow cooling process may take place in multiple cooling steps at progressively lower temperatures. In one embodiment, the cooling takes place in four steps wherein the material is first cooled to a temperature of between approximately 750° C. and 850° C., then cooled to a temperature of approximately 500° C.-600° C., followed by cooling to a temperature of between approximately 450° C. and 500° C., and finally, annealed by lowering the temperature to approximately 100° C.-200° C. In a typical process, wherein the starting material granulate is comprised of waste glass granulate, the initial stages in the cool down process last for between about 20 and 30 minutes, while the final stage lasts between about 40 and 50 minutes.

In order to obtain a sufficiently crystallized material, the annealed tile contained in the mold is sent through the thermal processing beginning with the preheating step at least one more time and preferable two more times. The final product will be have a structure that is at least 75 percent crystalline and preferably 90 percent crystalline. This process is time consuming and relatively inefficient. Fortunately, once a batch of the crystallized tiles has been produced, the tiles can themselves be ground into seed particles, facilitating the efficient and inexpensive production of subsequent batches of crystallized tiles according to the present invention.

Finally, the crystallized material is removed from the mold, crushed, and ground into crystallized seed particles having an approximately uniform size distribution. The crystalline phases obtained will depend on the initial glass composition and the specifics of the heat treatment. However, for a typical waste glass starting material processed according to the steps above, the seed particles produced will comprise mainly tridymite and devitrite crystals. In one embodiment at least 75 percent and preferably at least 90 percent of the resulting seed particle material is comprised of tridymite and/or devitrite. In addition, the seed particles may contain other crystalline mineral particles, including, but not limited to, cristobalite, wollastonite, and diopside. In various embodiments, the average diameter of the resulting crystallized seed particles is less than about 1 millimeter.

The present invention is further illustrated by the non-limiting examples provided below.

### EXAMPLES

### Example 1

Production of Crystalline Seed Particles.

Crystalline seed particles for use in the present invention were made by filling a heat resistant mold with a mixture of glass granulate having an average diameter of less than 2 millimeters. The mold was pre-treated with a thin film of a kaolin suspension. The glass granulate was of the Na₂O—CaO—SiO₂ type. The filled mold was placed in a modified ceramic kiln and the bottom of the mold was preheated using a bottom heating element until the glass particles reached a temperature of 700° C. for a period of 48 minutes. The glass layer in the mold was then fired by heating the bottom of the mold and the top of the mold simultaneously. During this process, the bottom of the mold was exposed to a temperature of about 975° C. to 1,000° C. and the top of the mold was exposed to a temperature of approximately 900° C. This stage of the firing process lasted for 24 minutes. In the second stage of the firing process, the bottom of the mold was maintained at a temperature of between about 975° C. and 1,000° C., while the top of the mold was exposed to a temperature of about 500° C. This step in the firing process also lasted for approximately 24 minutes.

The partially crystallized material was then slowly cooled to a temperature of 800° C. for 24-minutes. The material was then allowed to cool to a temperature of 550° C. for a period of 20 minutes, and then further cooled to a temperature of 480° C. for a period of 24 minutes. The material was then brought down to a final annealing temperature of 150° C. for a period of 48 minutes.

Upon completion of the annealing process, the mold containing the partially crystallized material was sent through the process, beginning with the preheating stage, two more times in order to produce a substantially completely crystallized tile.

The crystallized material was then removed from the mold, crushed, and ground until the size of the resulting seed particles was less than 1 millimeter. The seed particles were then used as nucleation sites in the production of crystallized construction materials.

### Example 2

Production of a One Layer Crystallized Construction Material.

A single layer crystallized construction material was made as follows. A homogeneous mixture of glass particles of the Na₂O—CaO—SiO₂ type and seed crystals of composed mainly of tridymite and devitrite, made according to Example 1 above, were placed into a heat resistant mold that had been pre-coated with a film of kaolin fluid suspension. The mixture comprised approximately 98 weight percent of the glass granulate and approximately 2 weight percent of the crystalline seed particles.

The filled mold was then placed into a modified ceramic kiln and the bottom of the mold was heated to a temperature of 700° C. over a bottom heating element. This preheating process lasted for 48 minutes. Next, the material in the mold was fired by heating the bottom of the mold to a temperature of between 975° C. to 1,000° C. and the top of the mold to a temperature of 850° C. to 900° C. for a time of 24 minutes. In a second stage, the firing process continued by maintaining the temperature of the bottom of the mold between 975° C. and 1,000° C. while increasing the temperature at the top of the mold to a temperature of about 950° C. This stage of the firing process also lasted for 24 minutes.

Once the firing process was complete, the mold and the material within was cooled in a series of cooling steps at progressively cooler temperatures. In the first step, the mold was cooled to a temperature of 700° C. for a 24-minute interval. Next, the mold was cooled to a temperature of 550° C. and maintained at this temperature for approximately 20 minutes to eliminate any temperature gradient within the materials. The mold was then cooled to a temperature of 480° C. for 24 minutes. And, finally, the mold was brought down to a final annealing temperature of 150° C. for 48 minutes.

The mechanical strength of the material was measured as follows. The material was thoroughly dried by heating it in an oven for 48 hours at about 65° C. A MOR/3-E/S machine, sold by Ceramic Instruments was used to measure the flexural modulus of rupture (MR) of the tile. Briefly, the tile was placed on the supporting bars of the instrument and a breaking pin was pressed down onto the tile until it broke. The instrument measured the load at breaking in kilograms (kg). The mechanical strength (i.e. MR) was calculated from the measured load as follows: MR=(3×P×D)/(2×W×H²) where P is the measured load in kg, D is the distance between the supports in centimeters (cm), W is the width of the tile in cm, and H is the thickness of the tile in cm.

The water absorption of the material was measured as follows. The material was thoroughly dried by heating it in an oven for 48 hours at about 150° C., followed by cooling in a dessicator. The tile was then weighed to determine the dry mass of the material. Next, the tile was placed in a pan of distilled water and boiled for five hours, then allowed to soak for an additional 24 hours. The soaked tile was then weighed again to determine the wet mass of the material. The water absorption (WA), expressed as a percent, is calculated as follows:

WA=((wet mass−dry mass)/dry mass)×100.

The final single layer material had a thickness of about 11 millimeters, a mechanical strength of about 25 MPa and a water absorption of about 0.2%.

### Example 3

Production of a Double Layer Construction Material

A two layer construction material having a crystallized bottom layer and a decorative upper layer was constructed as follows. A homogeneous mixture of glass granulate and crystalline seed particles was added to a heat resistant mold that had been pretreated with a thin film of a kaolin suspension to form a first layer in the mold. The glass granulate was of the Na₂O—CaO—SiO₂ type and had an average particle diameter of less than 1 millimeter. The crystalline seed particles were made as described in Example 1 and comprised mainly tridymite and devitrite crystals. The mixture contained approximately 98 weight percent glass granulate and 2 weight percent crystalline seed particles.

Next, a layer comprising colored glass granulate having an average diameter of 1-2 millimeters was placed on top of the first layer in the mold and leveled without pressure. The filled mold was then placed in a modified ceramic kiln and the bottom of the mold was preheated using a bottom heating element to a temperature of 700° C. during a 48-minute interval.

Next, the mold and the materials contained within the mold, were fired by heating both the top and the bottom of the mold with upper and lower heating elements. During the first stage of the firing process, the bottom of the mold was heated to a temperature of between 975° C. and 1,000° C., and the top of the mold was heated to a temperature of between 850° C. and 900° C. This first firing stage lasted for approximately 24 minutes. In a second firing stage, the bottom of the mold was maintained at a temperature of between 975° C. and 1,000° C., and the top of the mold was heated to a temperature of 950° C. This second stage of the firing process also lasted for 24 minutes.

Once the firing process was completed, the mold was cooled in a stepwise process to anneal the two layer construction material. The first step in the annealing process was to cool the layered material to a temperature of 700° C. for a 24-minute period. Next, the double layer material was cooled to a temperature of 550° C. and maintained at that temperature for 20 minutes in order to eliminate any temperature gradient existing within the layered material. Then, the two layer material was further annealed to a temperature of 480° C. during a 24-minute period, and finally, annealed by lowering the temperature to 150° C. for a 48-minute interval.

The mechanical strength and water absorption of the two layer material were measured as described in Example 1. The final double layer material had a thickness of about 11 millimeters, a mechanical strength of about 25 MPa and a water absorption of about 0.2%.

As will be understood by one skilled in the art, for any and all purposes, particularly in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third, and upper third, etc. As will also be understood by one skilled in the art, all language such as “up to,” “at least,” “greater than,” “less than,” and the like, include the number recited and refer to ranges which can be subsequently broken down into sub-ranges as discussed above.

While preferred embodiments have been illustrated and described, it should be understood that changes and modifications can be made therein in accordance with ordinary skill in the art without departing from the invention in its broader aspects as defined in the following claims.

What is claimed is:

1. A method for producing a single layer construction material comprising:
(a) forming a layer comprising a mixture of glass granulate and pre-formed crystalline seed particles; and
(b) crystallizing the glass granulate in the presence of the seed particles;
wherein the crystalline seed particles are made from a devitrified glassy material.

2. The method of claim 1 wherein the glass granulate comprises waste glass.

3. The method of claim 1 wherein the crystalline seed particles comprise crystalline minerals selected from the group consisting of tridymite, devitrite, cristobalite, wollastonite, diopside, and mixtures thereof.

4. The method of claim 1 wherein the seed particles have a diameter of less than about 1 mm.

5. The method of claim 1 wherein the glass granulate has an average particle diameter of less than about 4 mm.

6. The method of claim 1 wherein the glass granulate has an average particle diameter of less than about 1 mm.

7. The method of claim 1 wherein the mixture of glass granulate and crystalline seed particles comprises between about 98 and about 75 percent glass granulate by weight and between about 2 and about 25 percent crystalline seed particles by weight.

8. The method of claim 1 wherein crystallizing the glass granulates comprises:
(a) preheating the layer to a temperature sufficient to burn away any impurities in the layer;
(b) further heating the layer to a temperature sufficient to crystallize the glass granulate in the presence of the seed particles; and
(c) cooling the layer at a rate sufficient to anneal the layer.

9. A method for producing a double layer construction material comprising:
(a) forming a first layer comprising a mixture of glass granulate and pre-formed crystalline seed particles;
(b) disposing a second layer comprising glass granulate on top of the first layer;
(c) crystallizing the glass granulate in the first layer in the presence of the seed particles; and
(d) sintering the glass granulate in the second layer;
wherein the seed particles are made from a devitrified glassy material.

10. The method of claim 9 wherein the glass granulate comprises waste glass.

11. The method of claim 9 wherein the crystalline seed particles comprise crystalline minerals selected from the group consisting of tridymite, devitrite, cristobalite, wollastonite, diopside, and mixtures thereof.

12. The method of claim 9 wherein the crystalline seed particles have a diameter of less than about 1 mm.

13. The method of claim 9 wherein the glass granulate in the first layer has an average particle diameter of less than about 4 mm.

14. The method of claim 9 wherein the glass granulate in the second layer has an average particle diameter of less than about 1 mm.

15. The method of claim 9 wherein the coefficient of thermal expansion of the first layer is greater than the coefficient of thermal expansion of the second layer.

16. The method of claim 9 wherein the mixture of glass granulate and crystalline seed particles comprises between about 98 and about 75 percent glass granulate by weight and between about 2 and about 25 percent crystalline seed particles by weight.

17. The method of claim 9 wherein crystallizing the glass granulate in the first layer and sintering the glass granulate in the second layer comprises:
(a) preheating the first layer to a temperature sufficient to burn off any impurities in the layer;
(b) further heating the first layer to a temperature sufficient to crystallize the glass granulate in the first layer in the presence of the seed particles;
(c) heating the second layer to a temperature sufficient to sinter the glass granulate in the second layer; and
(d) cooling the first and second layers at a rate sufficient to anneal the layers.

18. A construction material comprising a layer of crystallized material produced from a mixture of glass granulate and pre-formed crystalline seed particles wherein the mixture has been thermally treated to crystallize the glass granulate in the presence of the crystalline seed particles, and further wherein the seed particles are made from a devitrified glassy material.

19. The construction material of claim 18 wherein the glass granulate comprises waste glass.

20. The construction material of claim 18 wherein the crystalline seed particles comprise crystalline minerals selected from the group consisting of tridymite, devitrite, cristobalite, wollastonite, diopside, and mixtures thereof.

21. The construction material of claim 18 wherein the seed particles have a diameter of less than about 1 mm.

22. The construction material of claim 18 wherein the glass granulate has an average particle diameter of less than about 4 mm.

23. The construction material of claim 18 wherein the mixture of glass granulate and crystalline seed particles comprises between about 98 and about 75 percent glass granulate by weight and between about 2 and about 25 percent crystalline seed particles by weight.

24. The construction material of claim 18 further comprising a second layer comprising a glassy material disposed on top of the first layer.

25. The construction material of claim 24 wherein the second layer is formed from sintered glass granulate.

26. The construction material of claim 24 wherein the first layer has a greater coefficient of thermal expansion than the second layer.
